(19) United States
(12) Patent Application Publication
(10) Pub. No.: US 2025/0123594 A1
(43) Pub. Date: Apr. 17, 2025

(54) WATCH

(71) Applicant: CASIO COMPUTER CO., LTD., Tokyo (JP)

(72) Inventors: Yuta SAITO, Tokyo (JP); Yoshihiro KOBAYASHI, Tokyo (JP)

(73) Assignee: CASIO COMPUTER CO., LTD., Tokyo (JP)

(21) Appl. No.: 18/829,108

(22) Filed: Sep. 9, 2024

(30) Foreign Application Priority Data
Oct. 13, 2023 (JP) 2023-177621

(51) Int. Cl. G04B 19/30; G04B 19/08

(52) U.S. Cl. CPC G04B 19/30; G04B 19/08

(57) ABSTRACT

A watch includes an annular light emitting member and an annular cover member. At least part of the cover member covers the light emitting member in a planar view from above. The cover member has a slope inclined upward as extending inward from an outside of the watch in a lower portion. The slope of the cover member includes a first slope portion and a second slope portion, in a cross-sectional view from a planar direction orthogonal to a vertical direction. The first slope portion has a linear shape. The second slope portion is located below the first slope portion. The second slope portion has a curved shape.

### CROSS-REFERENCE TO RELATED APPLICATION

This application is based upon and claims the benefit of priority from the Japanese Patent Application No. 2023-177621, filed Oct. 13, 2023, the entire contents of which are incorporated herein by reference.

### FIELD

The disclosure relates to a watch.

### BACKGROUND

A watch having a function of illuminating a display unit by a light source such as a light emitting diode (LED) in order to make the display unit such as a dial visible even in a dark place is known (for example, Jpn. Pat. Appln. KOKAI Publication No. 2007-155595). In the watch having such a function, if a portion of the light source having particularly high light emission intensity is located at a position where it is easy for a user to directly see the portion, it is difficult to visually recognize time due to the high light emission, and further, designability or luxuriousness of the watch is impaired. It is therefore preferable to dispose the portion having high light emission intensity at a position where it is difficult for the user to see the portion as much as possible.

### SUMMARY

A watch according to an aspect includes an annular light emitting member and an annular cover member. At least part of the cover member covers the light emitting member in a planar view from above. The cover member has a slope inclined upward as extending inward from an outside of the watch in a lower portion. The slope of the cover member includes a first slope portion and a second slope portion, in a cross-sectional view from a planar direction orthogonal to a vertical direction. The first slope portion has a linear shape. The second slope portion is located below the first slope portion. The second slope portion has a curved shape.

### BRIEF DESCRIPTION OF DRAWINGS

FIG. 1 is a plan view illustrating a configuration of a watch according to an embodiment.

FIG. 2 is an external view of a date wheel in the embodiment as viewed from above.

FIG. 3 is an external view of a solar panel in the embodiment as viewed from above.

FIG. 4 is a schematic view illustrating part of an internal configuration of the watch and part of optical paths of light from the solar panel.

FIG. 5A is a view illustrating comparison of optical paths of reflected light with respect to emission light of the solar panel due to a difference in a shape of a slope of a cover member.

FIG. 5B is a view illustrating comparison of the optical paths of the reflected light with respect to the emission light of the solar panel due to a difference in a shape of the slope of the cover member.

FIG. 5C is a view illustrating comparison of the optical paths of the reflected light with respect to the emission light of the solar panel due to a difference in a shape of the slope of the cover member.

FIG. 6 is a view illustrating an aspect in which light reflected by the cover member is further reflected by an hour mark.

### DETAILED DESCRIPTION

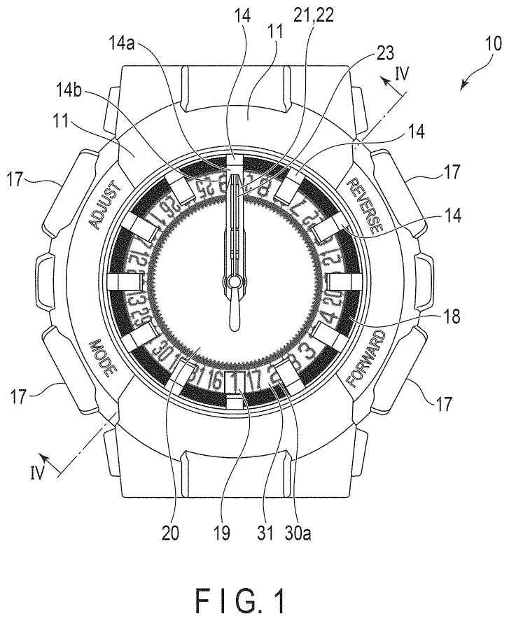

Hereinafter, an embodiment will be described with reference to the drawings. FIG. 1 is a plan view illustrating a configuration of a watch according to an embodiment. FIG. 1 is a plan view of the watch as viewed from an upward direction (above). Hereinafter, a surface of the watch illustrated in FIG. 1 will be described as a front face. In addition, components of the watch illustrated in each drawing described below may be appropriately enlarged, reduced, or omitted for convenience of description. A term “annular” in the embodiment does not necessarily mean “annular”. The term “annular” in the embodiment means a closed shape and may also include shapes other than an annular shape, for example, a rectangle shape. In addition, a “horizontal direction” in the embodiment is not necessarily limited to a horizontal direction with respect to the ground and may include meaning of a planar direction in which the watch is viewed from right beside.

As illustrated in FIG. 1, a watch 10 is, for example, an analog wristwatch, and includes a case 11 constituting an outline. The case 11 is a substantially annular case, and protective glass (or windshield glass) 20 is attached to a front side of the case 11 that houses a clock module 30 therein. The protective glass 20 is a colorless and transparent glass member having a relatively high light transmittance at least in a visible light band and is, for example, sapphire glass. Thus, external light that is light from the outside can pass through the protective glass 20 and enter the inside of the case 11.

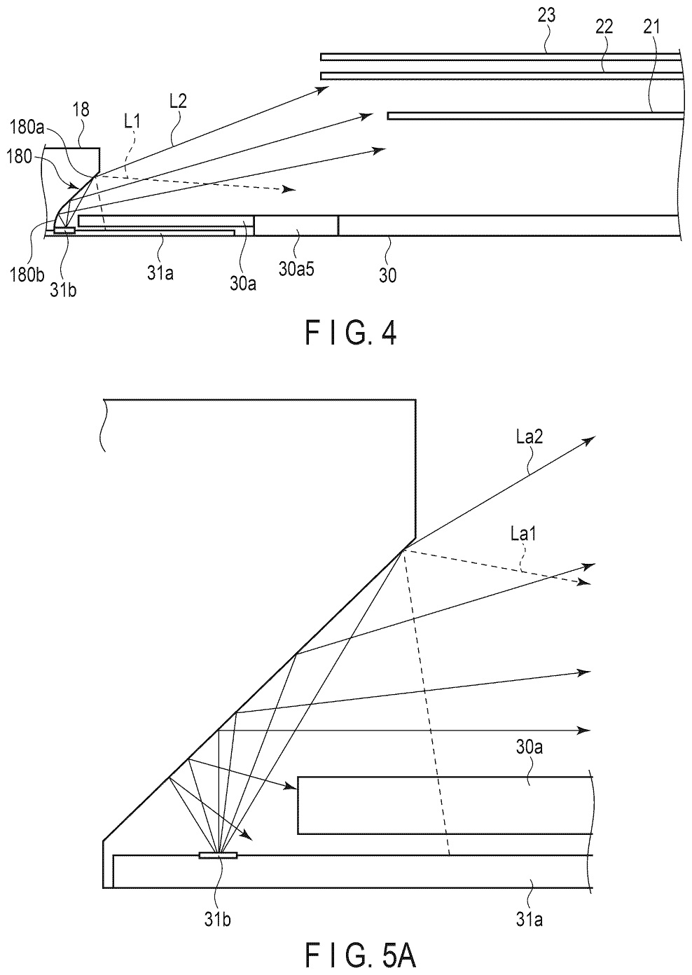

On an inner peripheral edge of the front side of the case 11, a cover member 18 for determining a parting shape of a display unit of the watch 10 is disposed. The display unit of the watch 10 is a region inside the inner peripheral edge of the front side of the case 11 in FIG. 1. In the present embodiment, the cover member 18 has a substantially annular shape at least as viewed from above. In addition, the cover member 18 is formed of brass and has a slope 180 facing the inside of the watch 10 in a lower portion as illustrated in FIG. 4. In other words, the slope 180 is inclined upward as extending inward from the outside of the watch 10. Here, the slope 180 is desirably mirror-finished, and for example, is plated with a material, for example, gold, which has relatively high reflectance, is hardly corroded, and easily reflects light in a red light band to be described later. In addition, if plating is performed with a metal material having relatively high reflectance, for example, plating may be performed with silver instead of gold. However, a layer plated with silver is more likely to be discolored and corroded than a layer plated with gold, and thus, a clear coat such as a urethane coat may be applied on the layer plated with silver. This makes it possible to prevent decrease in reflectance of the slope due to aging deterioration, or the like.

At least one reflecting member is provided on an upper portion of the cover member 18. In the present embodiment, 12 hour marks 14 are arranged at equal intervals at positions respectively corresponding to 1 o'clock to 12 o'clock as reflecting members. As viewed from above as illustrated in FIG. 1, the hour marks 14 are respectively arranged so as to protrude inward in a center direction of the watch 10 so as to cover part of a date wheel 30a described later. Each hour mark 14 may have a slightly different shape in order to avoid a decorative member (not illustrated), or the like, disposed on the display unit. A slope 14a as a third slope portion inclined toward the center of a ring forming the cover member 18, that is, toward the center of the watch 10 is formed on a side of each hour mark 14 viewed from above, for example, in order to reflect light by the surface as described later. In other words, the slope 14a is inclined downward as extending inward from the outside of the watch 10. An angle formed by a direction orthogonal to the vertical direction, that is, the planar direction or the horizontal direction in FIG. 1 in the watch 10, of the slope 14a of each hour mark 14 is preferably about 45° to 60°. In addition, at least the slope 14a is preferably formed of a material such as gold, silver, or stainless steel in order to increase reflectance of light on the surface and is preferably further subjected to mirror finishing by polishing, plating, or the like. In addition, there may be design irregularities as long as surface treatment such as mirror finishing is performed. Furthermore, mirror finishing may be performed not only on the slope 14a but also on a side surface 14b that is a side surface of the hour mark 14. In other words, the side surface 14b is a surface formed by the vertical direction and the planar direction or the horizontal direction, of the hour mark 14. In addition, the hour mark 14 itself may be formed of a material such as gold, silver, or stainless steel.

As a result, as will be described later, substantially all of the visible surfaces of the hour marks 14 can suitably reflect light from the inside of the watch 10, and the reflected light from the slopes 14a and the side surfaces 14b reaches the user's eyes E, so that substantially all of the visible surfaces of the hour marks 14 appear to emit light.

Note that, in the hour mark 14 on the 6 o'clock side, an area of the slope 14a is smaller than that of the other hour marks 14 due to a plate 19 allowing the user to recognize the date by a date wheel 30a being disposed, but in a case where a position of the plate 19 is disposed at a position slightly shifted along a circumferential direction of the watch 10 (date wheel 30a), the hour mark 14 on the 6 o'clock side can have the same shape as that of the other hour marks 14.

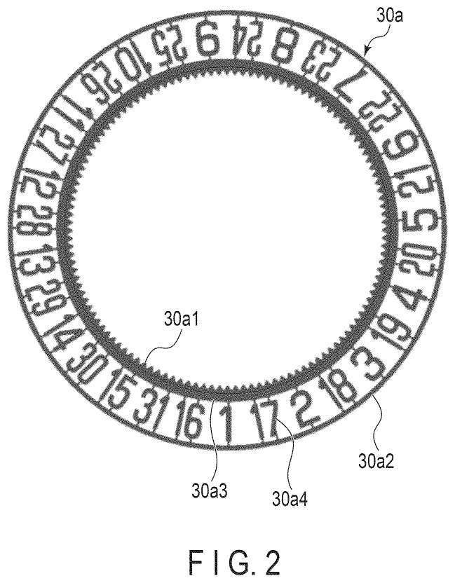

Inside the case 11, the date wheel 30a having a substantially annular shape as illustrated in FIGS. 1 and 2 is disposed to allow the user to recognize the date at a portion overlapping with the plate 19 in a case of being viewed from above. The date wheel 30a is disposed below the hour marks 14 so as to be covered by the hour marks 14 in the case 11 of being viewed from above. A tooth portion 30al is provided on an inner peripheral side of the date wheel 30a and is driven by a drive source and a gear (not illustrated). Further, a substantially annular solar panel 31 to be described later is provided below the date wheel 30a, and the date wheel 30a is arranged with a predetermined interval from the solar panel 31 by a support portion 30a5 provided on the inner peripheral side of the date wheel 30a.

The date wheel 30a is lightened while leaving an outer peripheral frame 30a2, an inner peripheral frame 30a3, and a character portion 30a4. In other words, the date wheel 30a penetrates along the vertical direction while leaving the outer peripheral frame 30a2, the inner peripheral frame 30a3, and the character portion 30a4. Here, the outer peripheral frame 30a2 and the inner peripheral frame 30a3 include a portion connecting the character portion from the outer peripheral side to the inner peripheral side and a portion connecting the character portion from the inner peripheral side to the outer peripheral side, respectively. As a result, in a case where the watch 10 is viewed from above, at least part of the solar panel 31 can be visually recognized through a thinned portion of the date wheel 30a. Note that the date wheel 30a is preferably formed of a metal material or a resin material from the viewpoint of ease of processing, and the like, but the surface is preferably not a mirror surface in order to avoid reflection of light from the solar panel 31 described later.

On an outer periphery of the case 11, one or more switches 17, four switches 17 in the example of FIG. 1, are provided so as to be exposed. Each switch 17 is electrically connected to a clock module to implement a predetermined function.

Furthermore, on the outer periphery of the case 11, a band to be worn on the user's arm is provided along a direction from 12 o'clock to 6 o'clock of the watch 10.

In a case where the watch 10 is an analog wristwatch, the clock module 30 includes hands, and a movement including a train wheel mechanism and a drive source of the train wheel mechanism. FIG. 1 illustrates a state in which three hands of a minute hand 21, an hour hand 22, and a second hand 23 overlap with each other. Although not illustrated, the clock module 30 includes a circuit board on which electronic components such as an antenna are mounted, and a secondary battery that supplies power for driving the electronic components.

Further, a dial may be attached to at least part of the front side of the clock module 30 as long as it does not hinder visual recognition of the date wheel 30a from above. In order to enable incidence of external light on the solar panel 31, in a case where the dial is attached to the clock module 30, the dial is desirably formed of a light transmissive material such as polycarbonate.

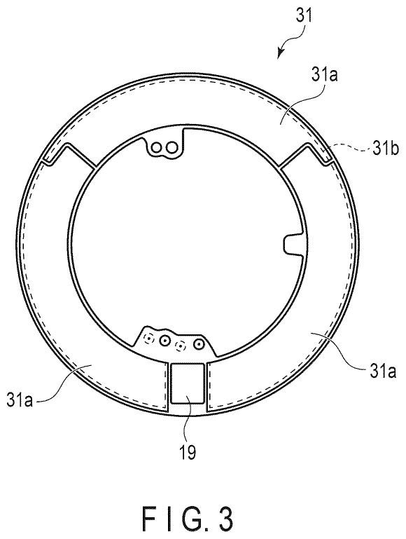

FIG. 3 is an external view of the solar panel 31 according to the embodiment as viewed from above. As illustrated in FIG. 3, the solar panel 31 in the embodiment has a substantially annular shape following the cover member 18. The solar panel 31 is, for example, an InGaP solar panel.

The solar panel 31 is disposed in the case 11, generates a current as a result of external light such as sunlight or indoor light being incident on the solar panel 31 (PN junction layer 31a) and charges the secondary battery with the current. In the present embodiment, at least part of the date wheel 30a penetrates along the vertical direction, and thus, the solar panel 31 can be charged by external light passing through the penetration portion. As will be described later, it is preferable that the date wheel 30a is provided such that a collector electrode 31b is in the shadow of the date wheel 30a as much as possible even in a case where the collector electrode 31b is visually recognized from an oblique direction in order to prevent light having high light emission intensity from directly entering the user's eyes E or in order not to impair designability and luxuriousness.

The solar panel 31 includes three solar cells having substantially equal areas, the PN junction layer 31a provided in each solar cell, the collector electrode 31b formed on an upper surface of the PN junction layer 31a, and an electrode layer (not illustrated) on at least part of a lower surface of the PN junction layer 31a. The solar panel 31 includes at least a structure in which the collector electrode 31b, the PN junction layer 31a, and the electrode layer are stacked in this order from the top. In this event, in a case of being viewed from above, there is a portion where the collector electrode 31b, the PN junction layer 31a, and the electrode layer all overlap with each other. A colorless and transparent protective film having relatively high light transmittance at least in a visible light band may be provided on the upper surface of the PN junction layer 31a in order to prevent deterioration, or the like.

The collector electrode 31b is formed at a position near the outer periphery of the solar panel 31 having a substantially annular shape and is connected to the secondary battery of the clock module 30 via, for example, a connection changeover switch. The collector electrode 31b can also be connected from the secondary battery to a light source drive circuit of the clock module 30 by switching the connection changeover switch.

As a result of light entering the PN junction layer 31a of the solar panel 31, the solar panel 31 generates power. In a case where the collector electrode 31b of the solar panel 31 is connected to the secondary battery, the secondary battery is charged by the generated current of the solar panel 31. Electronic components of the clock module 30 can be operated by the electric power stored in the secondary battery. On the other hand, in a case where the collector electrode 31b of the solar panel 31 is connected to the light source drive circuit, the solar panel 31 emits light by the current supplied from the light source drive circuit to the PN junction layer 31a via the collector electrode 31b. For example, if the PN junction layer 31a is an InGaP layer, the solar panel 31 emits light in a red band with a peak wavelength of about 660 nm.

Here, light emission occurs at a portion where coupling between electrons and holes occurs, which is a portion where a current flows in the PN junction layer 31a. In this event, current density in the vicinity of the collector electrode 31b is large, and thus, the current easily flows, so that the PN junction layer 31a particularly strongly emits light along the portion corresponding to the collector electrode 31b. As a distance from the collector electrode 31b increases, the PN junction layer 31a emits weaker light. In other words, in the solar panel 31, a position near the outer periphery emits light particularly strongly, and the other portion emits light more weakly than the position near the outer periphery.

Part of the PN junction layer 31a of the solar panel 31 is exposed inward so as to protrude from the cover member 18 to the center of the watch 10 in a case of being viewed from above, and thus is visible from at least above, and the entire circumference of the collector electrode 31b of the solar panel 31 is not visible from at least above by the cover member 18. Strictly speaking, the collector electrode 31b of the solar panel 31 has a substantially arc shape, but the collector electrode 31b is expressed as a substantially annular shape because the three substantially arc-shaped collector electrodes 31b are arranged to form a substantially annular shape.

In addition, a slope 180 is formed in the lower portion of the cover member 18 overlapping with the solar panel 31 (the PN junction layer 31a and the collector electrode 31b) in a case of being viewed from above, and the slope 180 has a first slope portion 180a and a second slope portion 180b having continuous surfaces and different shapes from each other. The collector electrode 31b is disposed so as to overlap with the second slope portion 180b in a case of being viewed from above. Note that the first slope portion 180a and the second slope portion 180b are not necessarily continuous surfaces and may be slightly separated at a boundary portion therebetween.

FIG. 4 is a schematic view illustrating part of the internal configuration of the watch 10 and part of the optical paths of light from the solar panel 31. FIG. 4 schematically illustrates a cross section taken along a line IV-IV in FIG. 1. Among the light emitted from the solar panel 31, a solid arrow L2 is light from the vicinity of the collector electrode 31b, and a broken arrow L1 is light penetrating the date wheel 30a from the PN junction layer 31a. In FIG. 1, the hands (minute hand 21, hour hand 22, and second hand 23) are illustrated as indicating a direction of 12 o'clock, but for convenience of description, the hands are illustrated as being on the line IV-IV in FIG. 4.

The first slope portion 180a is a slope formed on an upper side of the slope 180 in a lower portion of the cover member 18 and is a tapered slope in which an angle formed by the first slope portion 180a and the planar direction or the horizontal direction is inclined at an angle of approximately 45° from the outside to the inside of the cover member 18 in a cross-sectional view from the planar direction or the horizontal direction or is inclined at an angle of approximately 45°. In other words, the first slope portion 180a has a linear shape in a cross-sectional view from the planar direction or the horizontal direction orthogonal to the vertical direction.

The second slope portion 180b is a slope continuously formed from the first slope portion 180a on a lower side of the slope 180 in the lower portion of the cover member 18 and is a round slope in which an angle formed by the planar direction or the horizontal direction and the second slope portion 180b continuously changes from approximately 45° to approximately 90° in a cross-sectional view. In other words, the second slope portion 180b has a curved shape in a cross-sectional view from the planar direction or the horizontal direction orthogonal to the vertical direction. An end portion of the second slope portion 180b on the side not continuous with the first slope portion 180a has an angle of approximately 90° (about 80° to) 90° and is as close to the solar panel 31 as possible. A distance between the solar panel 31 and the second slope portion 180b may be as small as possible to the extent that at least insulation between the solar panel 31 and the second slope portion 180b is ensured. In addition, an insulating spacer may be interposed between the solar panel 31 and the second slope portion 180b so as to ensure insulation between the solar panel 31 and the second slope portion 180b. By making the distance between the solar panel 31 and the second slope portion 180b as short as possible (substantially abut) and setting the end portion of the second slope portion 180b on the side not continuous with the first slope portion 180a at an angle of approximately 90°, it is expected that leakage light to the outer peripheral side of the watch 10 upon light emission of the solar panel 31 (particularly, near the collector electrode 31b) is reduced. In other words, it is possible to prevent light emission to the display unit from appearing weak.

As described above, the date wheel 30a is disposed above the solar panel 31. It is desirable that a position of a rotation axis and an outer diameter of the date wheel 30a be determined so as not to block the light emitted from the solar panel 31 (particularly, near the collector electrode 31b), that is, so that the date wheel 30a is located outside the optical paths of the light emitted from the vicinity the collector electrode 31b. For example, if an outer diameter of the date wheel 30a is smaller than an inner diameter of the collector electrode 31b, the date wheel 30a can be disposed outside the optical paths of the light emitted from the vicinity of the collector electrode 31b. The light emitted from the vicinity of the collector electrode 31b includes light emitted from the PN junction layer 31a that emits light at a position corresponding to the collector electrode 31b.

With the configuration illustrated in FIG. 4, the light L1 and L2 emitted from the solar panel 31 is reflected by the first slope portion 180a or the second slope portion 180b on the optical paths. The light L1 and the light L2 include incident light and reflected light. The first slope portion 180a is a slope provided such that an angle formed by the planar direction or the horizontal direction and the first slope portion 180a is approximately 45°. Thus, the first slope portion 180a reflects light from the PN junction layer 31a mainly in an obliquely downward direction, that is, toward a region of the watch 10 inside the substantially annular solar panel 31. This can illuminate the vicinity of the center of the watch 10.

On the other hand, the second slope portion 180b is a slope provided such that an angle formed by the planar direction or the horizontal direction and the second slope portion 180b is continuously from approximately 45° to approximately 90°. Thus, the second slope portion 180b reflects the light from the vicinity of the collector electrode 31b mainly in the obliquely upward direction, that is, in the center (inner side) direction of the watch 10 and toward the hands (the minute hand 21, the hour hand 22, and the second hand 23). As a result of the hands being irradiated with the light from the vicinity of the collector electrode 31b, the hands appear to emit light. In addition, the light from the vicinity of the collector electrode 31b has higher light emission intensity than the light from the PN junction layer 31a, and thus, the vicinity of the center of the watch 10 appears to emit relatively weak light, and the hands appear to emit relatively strong light. As a result, the hands appear to be emphasized after the entire display unit becomes bright. Furthermore, a curvature of the second slope portion 180b may be set such that more light enters the hour marks 14.

In related art, a light emitting diode light source to be used for illumination of a watch is generally embedded in a point light source and a cover member, and as a result, time can be barely recognized even in a dark environment by light emission, but there is a situation in which only part of a display unit, for example, only in a direction of 5 o'clock is strongly illuminated, and light is unevenly emitted in the other portions. On the other hand, in the present embodiment, light incident from a position corresponding to the collector electrode 31b is incident (reflected) on the hands via the first slope portion 180a or the second slope portion 180b and is indirectly incident on the user's eyes E. The solar panel 31 and the cover member 18 have a substantially annular shape, and thus, the display unit of the watch 10 can be illuminated with substantially uniform illuminance along the annular shape of the cover member 18, and further, the hands can be emphasized and illuminated.

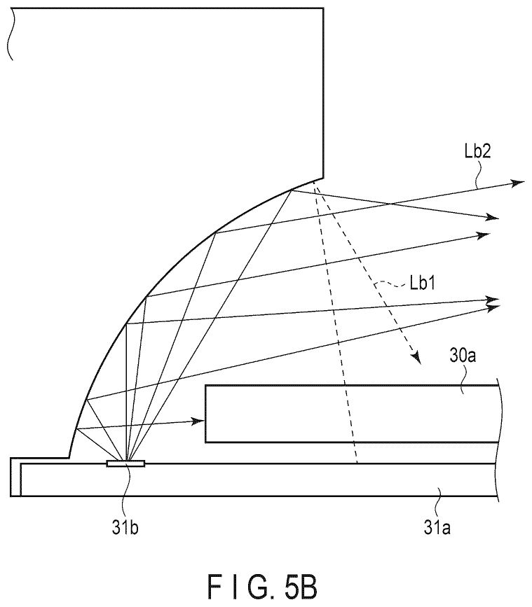

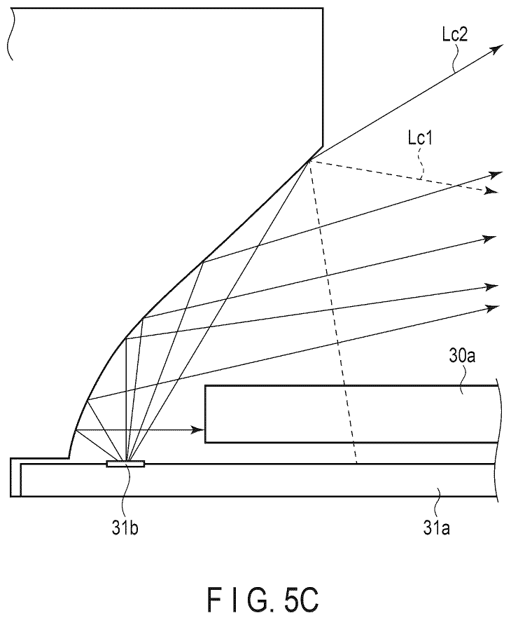

FIGS. 5A, 5B, and 5C are views illustrating comparison of the optical paths of the reflected light with respect to the emission light of the solar panel 31 due to a difference in a shape of the slope of the cover member 18. Here, FIG. 5A illustrates the optical paths of the reflected light in a case where only a tapered slope portion is formed in the cover member 18. FIG. 5B illustrates the optical paths of the reflected light in a case where only a round slope portion is formed in the cover member 18. FIG. 5C illustrates the optical paths of the reflected light in a case where both the tapered slope portion (first slope portion 180a) and the round slope portion (second slope portion 180b) are formed in the cover member 18. Note that FIGS. 5A, 5B, and 5C schematically illustrate only part of the light emitted from the solar panel 31 for convenience of description.

In a case of FIG. 5A, part of light La1 from the PN junction layer 31a travels toward a region inside the substantially annular solar panel 31 by the upper portion of the slope, so that it can illuminate the vicinity of the center of the watch 10. On the other hand, part of light La2 from the vicinity of the collector electrode 31b travels at a relatively lower position by the lower portion of the slope, and thus, the light is blocked by a side, or the like, of a member such as the date wheel 30a, and an amount of light toward the hands is relatively small. In addition, leakage light to the outer peripheral side of the watch 10 may also occur.

In other words, it can be said that while it is preferable to provide a tapered shape in the upper portion of the slope in order to cause the display unit to emit light, it is not preferable to provide a tapered shape in the lower portion of the slope in order to cause the display unit to emit light.

In a case of FIG. 5B, part of light Lb2 from the vicinity of the collector electrode 31b travels at a relatively high upper position by the lower portion of the slope, and thus, the light is not blocked by a member such as the date wheel 30a, and an amount of light directed toward the hands is relatively large. On the other hand, even if part of light Lb1 from the PN junction layer 31a is reflected by the upper portion of the slope, the part of the light Lb1 does not travel to the center of the watch 10 and travels downward again, so that the vicinity of the center of the watch 10 cannot be illuminated.

In other words, it can be said that it is preferable to provide the round shape in the lower portion of the slope in order to cause the display unit to emit light, but it is not preferable to provide the round shape in the upper portion of the slope in order to cause the display unit to emit light.

On the other hand, in a case of FIG. 5C, part of light Lc1 from the PN junction layer 31a travels toward a region inside the substantially annular solar panel 31 by the upper portion of the slope as illustrated in FIG. 5A, so that the vicinity of the center of the watch 10 can be illuminated. On the other hand, part of light Lc2 from the vicinity of the collector electrode 31b travels at a relatively high upper position by the lower portion of the slope as illustrated in FIG. 5B, and thus, the light is not blocked by a member such as the date wheel 30a, and an amount of light directed toward the hands is relatively large. It is therefore possible to increase an amount of light that can reach the eyes of the user without blocking the reflected light from the date wheel 30a, or the like. In other words, by providing the tapered shape in the upper portion of the slope and the round shape in the lower portion of the slope 180, it is possible to sufficiently illuminate the display unit including the hands. Furthermore, by adopting arrangement for suppressing exposure of the collector electrode 31b having high light emission intensity, it is possible to prevent deterioration in designability or luxuriousness.

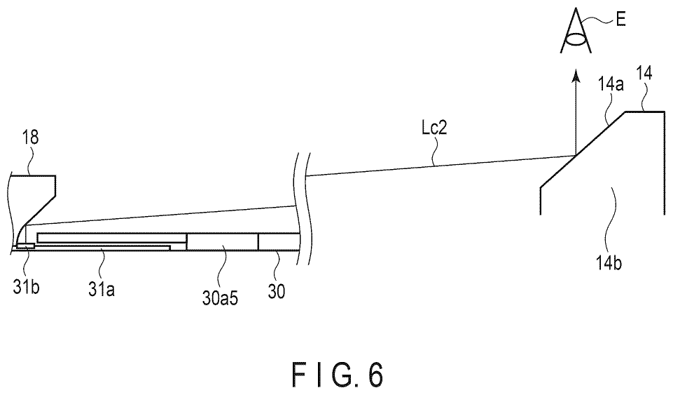

Furthermore, in a case of FIG. 5C, as illustrated in FIG. 6, the reflected light can also be delivered to the hour marks 14 substantially on the opposite side of the cover member 18, and the reflected light is further reflected by the slope 14a of each hour mark 14 set at an angle of about 45° to 60°, so that the reflected light from the slope 14a can reach the user's eyes E. In other words, the 12 hour marks 14 arranged at equal intervals are mainly irradiated with the reflected light from the vicinity of the collector electrode 31b having high light emission intensity, and thus, the position of each hour mark 14 can be recognized in a short period of time even in a dark environment, and the user can immediately recognize the time. In addition, the angle formed by the slope 14a of each hour mark 14 and the planar direction or the horizontal direction is preferably about 45° to 60°. In addition, in a case where the angle is about 60°, the reflected light from the slope 14a of each hour mark 14 travels closer to the center of the watch 10 than in a case of 45°, and thus, the time character 14 appears to be more emphasized.

On the other hand, light penetrating the date wheel 30a from the PN junction layer 31a and light from the vicinity of the collector electrode 31b can be incident on the side surfaces 14b of the hour marks 14. Thus, substantially all of the visible surfaces of the hour marks 14 appear to be shining, and the user can clearly recognize each time characters 14 even in a dark environment.

As illustrated in FIG. 1, black paint as a light absorbing layer is printed on a region of the upper surface of the cover member 18, the region being a surface between the respective hour marks 14. In this case, in a dark environment, each hour mark 14 appears to be shining and the light absorbing layer looks dark, so that each time character 14 appears to protrude to the outside of the watch 10. This also emphasizes each hour mark 14 in the dark environment, so that the user can recognize the time more immediately.

In addition, it is also expected that the light reflected by the round-shaped slope portion (second slope portion 180b) is obliquely incident on the tapered slope portion (first slope portion 180a) and is reflected again toward the outside of the cover member 18. This also makes it more likely to increase the amount of light that reaches the eyes of the user.

Note that each hour mark 14 and the solar panel 31, that is, a portion viewed from above of the PN junction layer 31a is illuminated brightly, while the date wheel 30a itself remains dark. In this event, each hour mark 14 protrudes toward the center of the watch 10, and thus, part of the date wheel 30a and the solar panel 31 is covered with each hour mark 14 as illustrated in FIG. 1, and the hour mark 14 can be made more conspicuous by contrast between each time hour mark 14 that appears to be shining by reflected light and the date wheel 30a that remains dark even upon light emission of the solar panel 31. This is more remarkable if combined with the light absorbing layer described above. As a result, the position of each hour mark 14 can be recognized in a short period of time even in a dark environment, and thus, the user can immediately recognize the time.

As described above, according to the embodiment, by forming the first slope portion 180a and the second slope portion 180b in the lower portion of the cover member 18 while disposing the substantially annular solar panel 31 as the light source member so as to partially overlap with the substantially annular cover member 18 in a case of being viewed from above, sufficient illumination of the display unit can be performed while the solar panel 31 is hidden to maintain designability and luxuriousness as a watch. In addition, the portion hidden by the cover member 18 is a portion near the collector electrode 31b that emits light particularly strongly in the solar panel 31. The portion near the collector electrode 31b is a portion that emits strong light but hardly contributes to power generation. By intentionally not hiding part of the portion that contributes to power generation by the cover member 18 like the PN junction layer 31a, it is also possible to prevent decrease in power generation efficiency.

The present invention is not limited to the above embodiment, and various modifications can be made in an implementation stage without departing from the gist thereof.

In the above-described embodiment, the substantially annular solar panel 31 is used as the light source member. On the other hand, the light source member does not necessarily have a power generating function. In other words, the light source member may be LEDs arranged in a substantially annular shape and an annular light guide member accommodating each LED. Furthermore, the light source member is not necessarily formed in an annular shape. For example, the light source member may be a plurality of point light sources arranged as closely to each other as possible in a substantially annular shape.

Furthermore, in the above-described embodiment, an analog wristwatch has been described as an example of the watch 10, but a digital wristwatch including a liquid crystal display surface of a segment type, a dot matrix type, or the like, inside the solar panel 31 may be used. As a result, the entire periphery of the display unit including the liquid crystal display surface can be illuminated. Further, in a case of a digital wristwatch, the date wheel 30a and the time characters 14 do not have to be provided.

In addition, in the above-described embodiment, the description has been made in which the reflected light can also be delivered to the time characters 14 on the substantially opposite side of the cover member 18. However, for example, in a case where a member having a height, in other words, a thick member, for example, a gear, a large decorative member, a magnetic resistant plate, or the like, is arranged along the vertical direction in the inner region of the solar panel 31, the reflected light does not reach the hour marks 14 on the substantially opposite side of the cover member 18 as illustrated in FIG. 6, and a phenomenon that the solar panel 31, that is, a portion visible from above the PN junction layer 31a emits light, but the slope 14a of each hour mark 14 is particularly dark occurs. However, as in the previously described embodiment, each hour mark 14 protrudes toward the center of the watch 10, and thus, also in this case, part of the date wheel 30a and the solar panel 31 (PN junction layer 31a) is hidden by each hour mark 14, allowing the hour marks 14 to be conspicuous by contrast between the solar panel 31 (PN junction layer 31a) that emits light and each hour mark 14 and date wheel 30a that remain dark upon light emission of the solar panel 31. This also allows the user to immediately recognize the time even in a dark environment. Note that in this case, each hour mark character 14 can be recognized without the date wheel 30a.

In addition, the embodiment may be implemented in appropriate combination, and in that case, combined effects can be obtained. Furthermore, the above-described embodiment includes various inventions, and various inventions can be extracted by a combination selected from a plurality of disclosed components. For example, even if some components are deleted from all the components indicated in the embodiment, if the problem can be solved and the effects can be obtained, a configuration from which the components are deleted can be extracted as the invention.

What is claimed is:

1. A watch comprising:
an annular light emitting member; and
an annular cover member at least part of which covers the light emitting member in a planar view from above, and having a slope inclined upward as extending inward from an outside of the watch in a lower portion,
wherein the slope of the cover member includes a first slope portion and a second slope portion, in a cross-sectional view from a planar direction orthogonal to a vertical direction, the first slope portion having a linear shape, and the second slope portion located below the first slope portion and having a curved shape.

2. The watch according to claim 1, comprising:
at least one reflecting member having a third slope portion inclined downward as extending inward from the outside of the watch in an upper portion of the cover member,
wherein the third slope portion has a mirror surface.

3. The watch according to claim 2, wherein an angle formed by the third slope portion and the planar direction is 45° to 60°.

4. The watch according to claim 2, wherein the reflecting members are arranged at equal intervals along a circumferential direction of the cover member in planar view from above.

5. The watch according to claim 4, wherein the reflecting members are 12 hour marks arranged at equal intervals along the circumferential direction of the cover member in planar view from above.

6. The watch according to claim 5, wherein a light absorbing layer is provided in a region on an upper portion of the cover member, the region being between the 12 hour marks.

7. The watch according to claim 2, wherein
each of the reflecting members has a side surface portion along a surface formed by the vertical direction and the planar direction, and
the side surface portion has a mirror surface.

8. The watch according to claim 2, comprising:
an annular date wheel penetrating above the light emitting member and below the reflecting members along the vertical direction while leaving an outer peripheral frame, an inner peripheral frame, and a character portion,
wherein at least part of the reflecting members protrudes inward of the watch from the cover member so as to cover the date wheel in planar view from above.

9. The watch according to claim 8, wherein
the light emitting member includes at least an annular collector electrode in an upper portion, and
the collector electrode is disposed at a position overlapping with the second slope portion in planar view from above.

10. The watch according to claim 9, wherein an outer diameter of the outer peripheral frame of the date wheel is smaller than an inner diameter of the collector electrode.

11. The watch according to claim 1, wherein
an end portion of the second slope portion on a side of the light emitting member abuts on the light emitting member, and
the second slope portion is inclined such that an angle formed with the planar direction becomes closer to 90° as approaching the light emitting member.
